(19) United States
(12) Patent Application Publication
(10) Pub. No.: US 2007/0127709 A1
(43) Pub. Date: Jun. 7, 2007

(54) Terminal apparatus

(75) Inventor: Toshiaki Takahashi, Hino-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/601,700

(22) Filed: Nov. 20, 2006

(30) Foreign Application Priority Data
Nov. 22, 2005 (JP) 2005-337411

(51) Int. Cl. H04M 1/00; H04M 9/00

(52) U.S. Cl. 379/388.03

(57) ABSTRACT

According to one embodiment, a terminal apparatus includes a processor which amplifies a reception voice signal to transmit it to the voice input/output device by a voice amplifier capable of arbitrary setting an amplification gain and amplifies a transmission voice signal transmitted from the voice input/output device by the voice amplifier, a memory which stores a communication level setting value corresponding to registered name information showing the voice input/output device, an acquiring unit which acquires the registered name information from the voice input/output device through a radio communication in connecting the voice input/output device, and a controller which reads out a communication level setting value corresponding to the acquired registered name information from the memory, and controls the amplification gain of the voice amplifier based on the communication level setting value.

### CROSS-REFERENCE TO RELATED APPLICATIONS

This application is based upon and claims the benefit of priority from Japanese Patent Application No. 2005-337411, filed Nov. 22, 2005, the entire contents of which are incorporated herein by reference.

### BACKGROUND

1. Field

One embodiment of the invention relates to a terminal apparatus which has a telephone application function capable of connecting a headset via a radio communication line and capable of making a voice communication through the headset.

2. Description of the Related Art

A telephone set performing a voice communication (transmission and reception) can make a communication by connecting such a headset in which a microphone is mounted on a headphone or an earphone so as to communicate in a manner that both hands are free in addition to communicate through a handset.

Other than this, a headset which is connected without wires and further increases a freedom degree of an action. More specifically, limiting to a distance near by the telephone set, a Bluetooth headset (hereinafter, referred to as BT headset) using a radio communication means called the Bluetooth (hereinafter, referred to as BT) has been widely used (for instance, refer to Jpn. Pat. Appln. KOKAI No. 2003-32175).

Meanwhile, regardless of the BT headset, headsets differ in communication level in default states depending on the models and manufactures thereof. In this case, when the connection of the BT headset brings a sound volume of the reception into too large or too small, the BT headset is used by adjusting the sound volume in use of a reception volume controller of the telephone set or the BT headset. However, in the case of the telephone set or the BT headset in which the sound volume gets back to a default value for a communication, the necessity of operation of the volume controller for each communication troubles a user.

When the sound volume of the transmission is too large or too small, the user has to adjust to make a level large or small by setting the telephone set or the BT headset. For one example of the case in which the sound volume is set by means of the telephone set, an operation to make the BT headset enter a setting mode in accordance with a specific key operation in an idle state bringing the telephone set into an non-telephone call state, and to adjust a reception amplification gain and a transmission amplification gain in a telephone call situation of the BT headset is a possible approach.

Like this, a weak point of the head set is that each connection thereof requires individual and troublesome setting of its communication level.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary outer appearance illustrating a first embodiment of a telephone set and a BT headset regarding the present invention;

FIG. 2 is an exemplary block diagram illustrating a circuit configuration of a telephone set main body in the first embodiment of the present invention;

FIG. 3 is an exemplary view illustrating one example of storage contents of a storage unit shown in FIG. 2;

FIG. 4 is an exemplary block diagram illustrating a configuration example of a voice processing unit shown in FIG. 2;

FIG. 5 is an exemplary view illustrated for explaining an example of a variable width specification of a reception gain and a volume controller based on the conventional art;

FIG. 6 is an exemplary view illustrated for explaining an example of a variable width specification of a reception gain and a volume controller applied to the first embodiment of the present invention;

FIG. 7 is am exemplary block diagram illustrating a configuration in the case in which an echo canceller is included in a voice processing unit as a second embodiment of the present invention; and

FIG. 8 is an exemplary block diagram illustrating a configuration in the case in which a noise canceller is included in a voice processing unit as a third embodiment of the present invention.

### DETAILED DESCRIPTION

Various embodiments according to the invention will be described hereinafter with reference to the accompanying drawings, In general, according to one embodiment of the invention, a terminal apparatus which has a telephone application function to reproduce acoustically and to output a voice signal and to be connected to a cable communication line, can connect a voice input/output device to input the voice signal via a radio communication line, comprising: a processor which amplifies a reception voice signal to transmit it to the voice input/output device by a voice amplifier capable of arbitrary setting an amplification gain and amplifies a transmission voice signal transmitted from the voice input/output device by the voice amplifier; a memory which stores a communication level setting value corresponding to registered name information showing the voice input/output device; an acquiring unit which acquires the registered name information from the voice input/output device through a radio communication in connecting the voice input/output device; and a controller which reads out a communication level setting value corresponding to the acquired registered name information from the memory, and controls the amplification gain of the voice amplifier based on the communication level setting value.

### FIRST EMBODIMENT

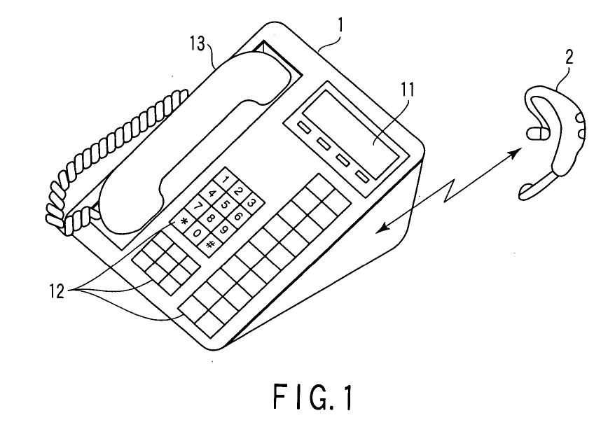

FIG. 1 is an outer appearance view showing a first embodiment of a telephone set and a BT headset regarding the present invention.

In FIG. 1, a BT headset 2 as a voice input/output device is connected to a telephone set main body 1 by radio. A display unit 11 using an LCD, etc., is arranged on a front panel part of the telephone set main body 1, further, a key matrix 12 composed of a dial key, a function key, etc., is disposed on a lower panel part of the display unit 11. A handset 13 with a loud-speaker and a microphone is arranged on the left side of the front panel part of the telephone set main body 1.

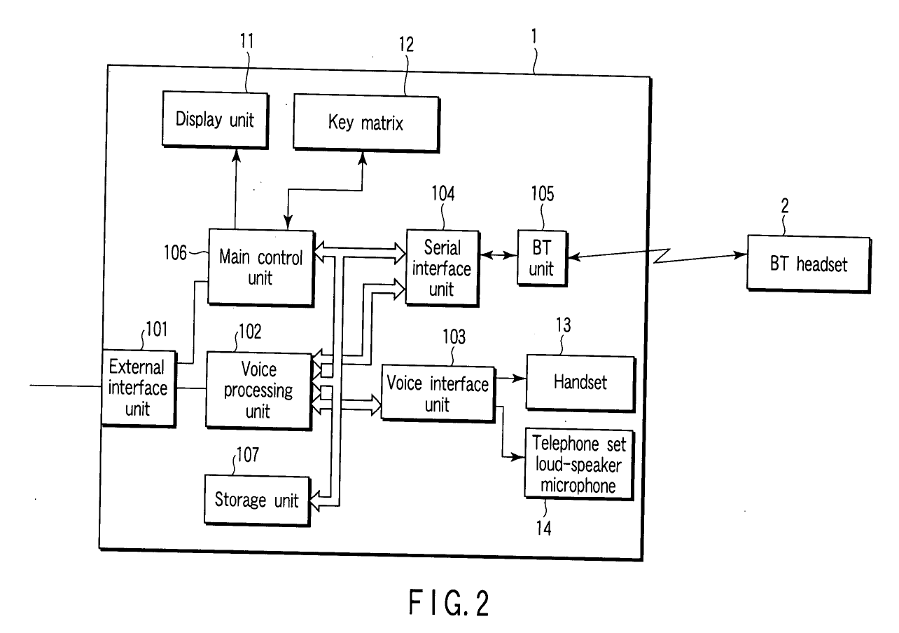

On the other hand, a circuit configuration of the telephone set main body 1 is described as follows. FIG. 2 is a block diagram showing the configuration.

As shown in FIG. 1, the telephone set main body 1 includes an external interface (I/F) unit 101, a voice processing unit 102, a voice interface unit 103, a serial interface unit (S I/O) 104, a BT unit 105, a main control unit 106, and a storage unit 107.

The external interface unit 101 conducts an interface processing relating to an internet protocol (IP) network to which the external interface unit 101 is connected. That is, the external interface unit 101 extracts voice data and control data from a transmission packet transmitted from the IP network to transfer the voice data to the voice processing unit 102 and the control data to the main control unit 106. The external interface unit 101 multiplexes the data supplied from the main control unit 106 onto the voice data supplied from the voice processing unit 102 to transmit it to the IP network.

The voice processing unit 102 amplifies the voice data supplied from the external interface unit 101 by a prescribed level to supply it to the voice interface unit 103 and the serial interface unit 104. The voice processing unit 102 amplifies transmission voice data input from the voice interface unit 103 and the serial interface unit 104 by a prescribed level to supply it to the external interface unit 101.

A handset 13 and a telephone set, loud-speaker, and microphone 14 are connected to the voice interface unit 103. After digital-converting the transmission voice signal input from the microphone of the handset 13 or the telephone set, loud-speaker and microphone 14 into transmission voice data, the voice interface unit 103 inputs it to the voice processing unit 102. After analog-converting the reception voice data output from the voice processing unit 102, the voice interface unit 103 acoustically reproduces it from the loud-speaker of the handset 13 or the telephone set, loud-speaker and microphone 14.

The BT unit 105 is connected to the serial interface unit 104. The BT unit 105 communicates to and from the BT headset 2 via the radio communication line, transmits an authentication request to the BT headset 2 and also receives a BT address and BT registered name information transmitted from the BT headset 2 in response to the authentication request to register the registered name information. Further, the BT unit 105 transmits the reception voice signal and receives the transmission voice signal transmitted from the BT headset 2. The registered name information registered in the BT unit 105 is read out by the main control unit 106.

The serial interface unit 104 digital-converts the transmission voice signal input from the BT unit 105 into the transmission voice data then inputs it to the voice processing unit 102. After analog-converting the reception voice data output from the voice processing unit 102 into the reception voice signal, the serial interface unit 104 outputs it to the BT unit 105. Thereby, the reception voice signal is supplied to the BT headset 2 from the BT unit 105 via the radio communication line to be acoustically reproduced from the loud-speaker of the BT headset 2.

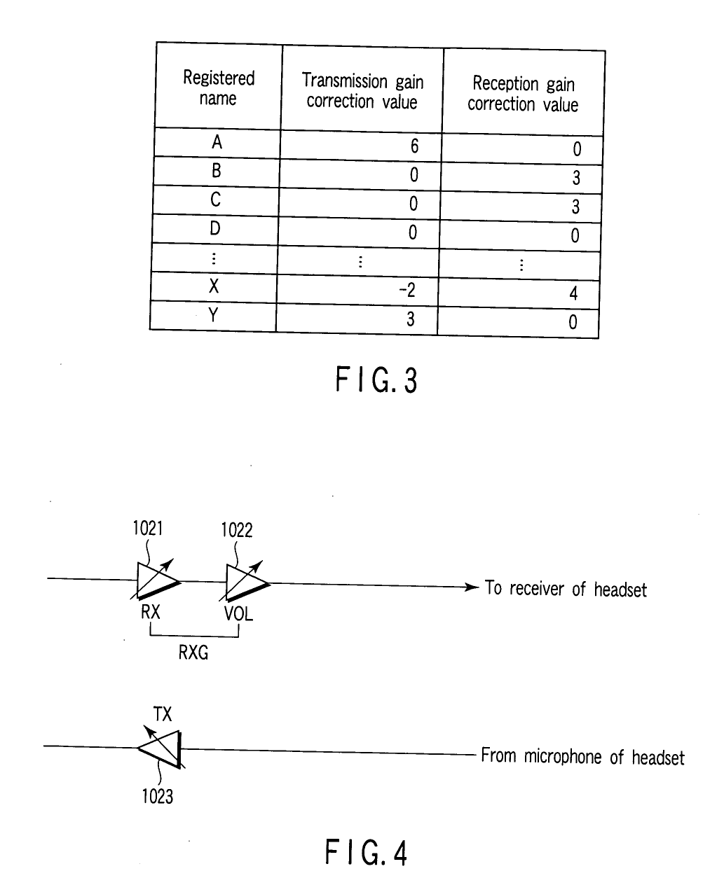

In the storage unit 107, as shown in FIG. 3, stores transmission gain correction values and reception gain correction values which accord with communication volume standards when the BT headset 2 which has been already performance-confirmed is connected to the telephone set main body 1 together with the “BT registered name” of the BT headset 2. In usual, since the BT headset 2 which has been already performance-confirmed are present plurally, transmission gain correction values and the reception gain correction values are stored for each BT headset 2. Here, this storage is called a headset list. For instance, it means that the BT headset 2 having a BT registered name of “A” increases the transmission gain by 6 dB, and the reception gain of the BT headset 2 accords with the communication volume standard without any correction.

The main control unit 106 conducts control of each part of the telephone main body 1 and a communication processing to and from the IP network by means of a software processing. When the sound volume value setting from the user is accepted through the key matrix 12, the main control unit 106 makes the voice processing unit 102 adjust the sound volume value of the loud-speaker volume controller to the set volume value. The main control unit 106 makes the display unit 11 display the adjusted result. The main control unit 106 may use turning on or turning on and off of the LED, etc.

The main control unit 106 reads out the BT registered name information from the BT unit 105, and compares the BT registered name information with the BT registered name information stored in the storage unit 107. When both information matches with each other, the main control unit 106 reads out the corresponding transmission gain correction value and the reception gain correction value. The main control unit 106 then controls amplification gains of a reception amplifier and a transmission amplifier in the voice processing unit 102 based on the transmission gain correction value and the reception gain correction value.

Next to this, operations in the foregoing configuration will be set forth.

At first, when the BT headset 2 desired to be connected and the telephone set main body 1 are paired, the BT registered name of the BT headset 2 is registered in the BT unit 105. The main control unit 106 reads out the information on the registration to check with the BT headset list in the storage unit 107. If there are the identical registered names, the main control unit 106 coordinates the transmission amplifier gain and the reception amplifier gain of the voice processing unit 102 with the correction values in the BT headset list to change them. Thereby, the connected BT headset 2 reaches such a level to match with the communication volume standard without having to perform a level adjustment.

Regarding the setting of the level will be described in a little more detail hereinafter.

FIG. 4 is a configuration example of the voice processing unit 102. A reception gain RXG is a sum of a gain RX of a reception amplifier 1021 and a gain VOL of a volume controller 1022. A gain TX of a transmission amplifier 1023 is a gain thereof as it is.

For example, sensitivity of a loud-speaker of the BT headset 2 with the BT registered name “X” is low, and the reception gain has to be increased by 4 dB when the BT headset 2 is connected to the telephone set main body 1. In contrast, the transmission level being a little bit high, the transmission level should be decreased by 2 dB so as to match with a communication level reference.

As one of conventional methods, there is a method for increasing the reception level by operating a volume button in the key matrix 12 of the telephone set main body 1. This method sets the volume controller 1022 to +4 dB. (a) and (b) of FIG. 5 each show the reception gains RXGs and the volume variable widths. This cannot change the transmission gain.

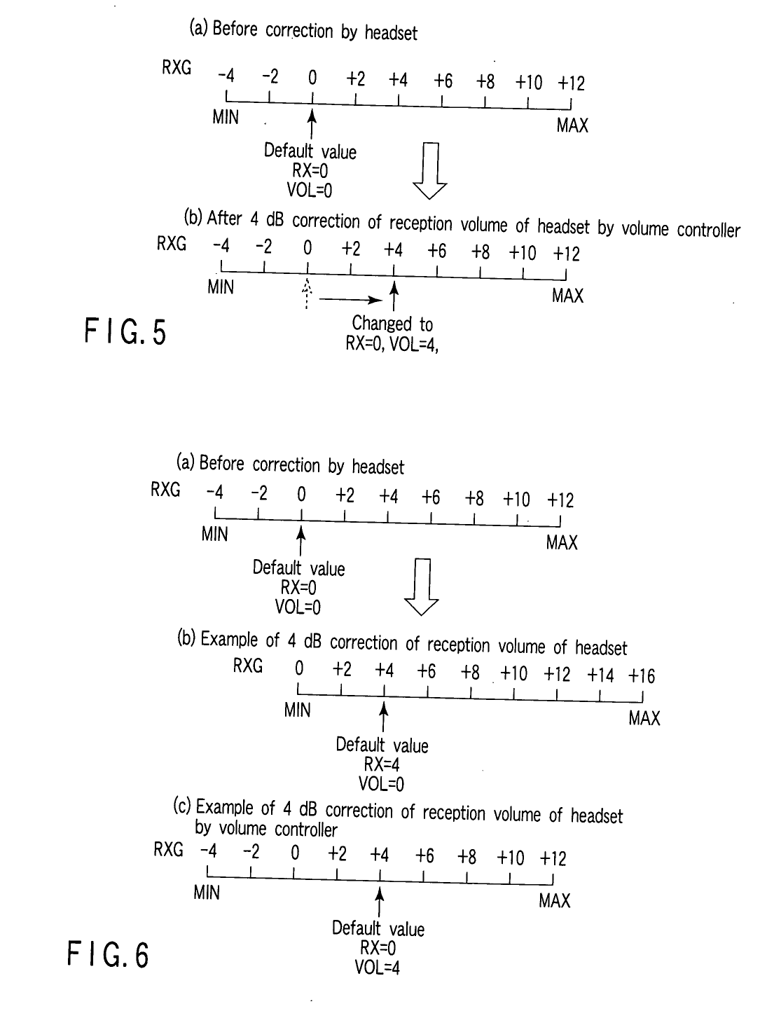

Therefore, the present invention changes the gain RX of the reception amplifier 1021 and the gain TX of the transmission amplifier 1023. In this case, the reception gain RX is increased by 4 dB because the reception is increased by 4 dB, and the transmission gain TX is decreased by 2 dB because the transmission is decreased by 2 dB. (a) and (b) of FIG. 6 each show the reception gains RXGs and the volume variable widths. This method can correct both transmission and reception. Even a device the volume value of which returns to the default values for each communication, it accords with the communication volume standard. In adjusting the volume controller 1022, as shown at (c) of FIG. 6, the gain RX of the reception amplifier 1021 is set to “0”. Thereby, the setting becomes easy when the BT headset 2 is connected to the telephone set main body 1.

As mentioned above, in the first embodiment, the registered name information, the transmission gain correction values, and the reception gain correction values of the BT headset 2 to be connected are associated with one another to register them in the storage unit 107 of the telephone set main body 1. When the BT headset 2 is connected through the BT unit 105, the BT registered name information is acquired from the BT headset 2 to register it by using the authentication procedure on the radio communication lime. The main control unit 106 then reads out the transmission gain correction value and the reception gain correction value corresponding to the BT registered name information to control each gain of the reception amplifier 1021 and the transmission amplifier 1023 of the voice processing unit 102 based on the transmission gain correction value and the reception gain correction value.

Accordingly, in the case in which the BT headset 2 like the Bluetooth via the radio communication line, the BT headset 2 can automatically set an optimum communication level without individually setting through manual operations by the user.

### SECOND EMBODIMENT

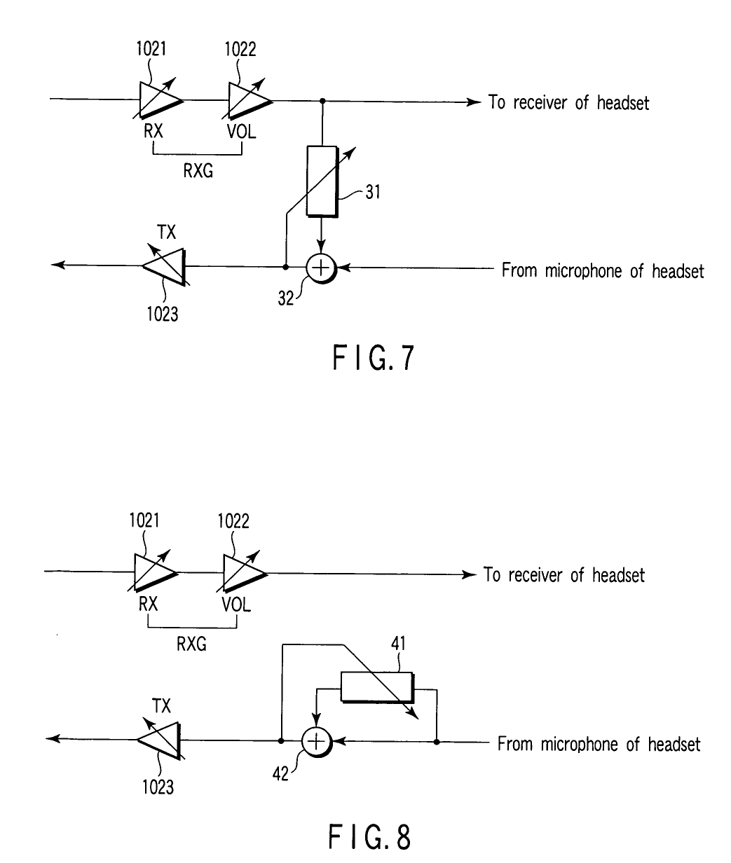

FIG. 7 is a block diagram showing a configuration of a voice processing unit 102 in a second embodiment of the present invention. In FIG. 7, the same components as those of FIG. 4 are designated by the identical symbols and their detailed descriptions are eliminated.

That is to say, an echo canceller and an adder 32 are interposed between the output side of the volume controller 1022 and the input side of the transmission amplifier 1023.

The echo canceller 31 inputs an output signal from the volume controller 1022 to generate a signal to remove acoustic echoes added to the input signal from the transmission amplifier 1023. The output signal from the echo canceller 31 is added to the output signal from the serial interface 104 through the adder 32 then the acoustic echoes added to the transmission voice signal are reduced.

Next, operations in the aforementioned configuration will be described.

The BT headset 2 is miniaturized and lightened, so that some BT headsets 2 have adverse affects, such as acoustic coupling that is creeping of sounds from a loud-speaker because the loud-speaker and the microphone are positioned close to each other and surrounding noise is easily picked because the microphone is positioned too close to an ear and away from the mouse of a speaker, on communication performance resulting from the miniaturization.

For the user of such BT headset 2, providing the echo canceller 31 for the voice processing unit 102 in the telephone set main body 1 makes it possible for the BT headset 2 to complement poorness of the performance thereof.

As given above, in the second embodiment, the transmission voice signal having been amplified by the transmission amplifier 1023 after the cancellation of the acoustic echoes by the echo canceller 31, the acoustic echoes added to the transmission voice signal may be further reduced.

### THIRD EMBODIMENT

FIG. 8 is a block diagram depicting a configuration of a voice processing unit 102 in a third embodiment of the present invention. In FIG. 8, the same components as those of FIG. 4 are designated by the identical symbols and detailed descriptions are eliminated.

That is, a noise canceller 41 and an adder 42 are interposed on an input side of the transmission amplifier 1023.

The noise canceller 41 inputs an output signal from the serial interface unit 104 to generate a signal to remove noises added to the input signal to the transmission amplifier 1023. The output signal from the noise canceller 41 is added to the output signal from the serial interface unit 104 by the adder 42 then the noises added to the transmission voice signal are reduced.

As given above, in the third embodiment, the transmission voice signal having been amplified by the transmission amplifier 1023 after the cancellation of the noises by the noise canceller 41, the noises added to the transmission voice signal may be further reduced.

### OTHER EMBODIMENT

The present invention is not limited to the foregoing each embodiment. For instance, in the second and third embodiments, it is more preferable that the echo canceller and noise canceller are not used if possible in terms of an increase in bottom noise. Some relatively expensive BT headsets prevent the acoustic coupling by mounting the loud-speaker in a different house form that of the microphone, or make it hard to pick the surrounding noises by suing a microphone unit of a noise canceling type. It is much better for the headset taking such measures not to operate the echo canceller and noise canceller. Conventionally, a telephone set having separately set the operation/non-operation of the echo canceller and noise canceller, according to the present invention, storing the operation/non-operation of the echo canceller as items of the headset list makes the setting unnecessary in the case of accordance of the BT registered name.

In the aforementioned each embodiment, the telephone set connected to the IP network having described as an example, the present invention is not limited to the embodiments and may be applied to a telephone set to be connected to an analog line.

In each embodiment, the present invention may also be applied to a personal computer with a telephone application mounted thereon and electronic equipment treating a voice signal. The present invention may be applied to a voice input/output device other than a headset to be connected via the radio communication line.

Other than this, various modifications of types and their configurations of terminal devices such as telephone sets, types of headsets, and kinds of communication level setting values such as transmission gain correction values and reception gain correction values may be made within a range not departing from the principle of the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A terminal apparatus which has a telephone application function to reproduce acoustically and to output a voice signal and to be connected to a cable communication line, can connect a voice input/output device to input the voice signal via a radio communication line, comprising:
a processor which amplifies a reception voice signal to transmit it to the voice input/output device by a voice amplifier capable of arbitrary setting an amplification gain and amplifies a transmission voice signal transmitted from the voice input/output device by the voice amplifier;
a memory which stores a communication level setting value corresponding to registered name information showing the voice input/output device;
an acquiring unit which acquires the registered name information from the voice input/output device through a radio communication in connecting the voice input/output device; and
a controller which reads out a communication level setting value corresponding to the acquired registered name information from the memory, and controls the amplification gain of the voice amplifier based on the communication level setting value.

2. The terminal apparatus according to claim 1, wherein
the memory stores a transmission gain correction value and a reception gain correction value as the communication level setting value by associating with the registered name information; and
the controller reads out a transmission gain correction value and a reception gain correction value corresponding to the registered name information acquired in connecting the voice output/input device, and controls the amplification gain of the voice amplifier based on the transmission gain correction value and the reception gain correction value.

3. The terminal apparatus according to claim 1, further comprising: an echo canceller which eliminates acoustic echoes added to the transmission voice signal before the transmission voice signal is input to the voice amplifier.

4. The terminal apparatus according to claim 3, wherein
the memory stores operation information showing whether the echo canceller should be operated or not by associating with the registered name information; and
the controller reads out operation information corresponding to the registered name information acquired in connecting the voice input/output device, and controls execution/stop of the echo canceller based on the operation information.

5. The terminal apparatus according to claim 1, further comprising; a noise canceller which eliminates noises added to the transmission voice signal before the transmission voice signal is input to the voice amplifier.

6. The terminal apparatus according to claim 5, wherein
the memory stores operation information showing whether the noise canceller should be operated or not by associating with the registered name information; and
the controller reads out operation information corresponding to the registered name information acquired in connecting the voice input/output device, and controls execution/stop of the noise canceller based on the operation information.
